(19) United States
(12) Patent Application Publication
(10) Pub. No.: US 2010/0068675 A1
(43) Pub. Date: Mar. 18, 2010

(54) IMPLANT HAVING A CORE

(75) Inventor: Arik Zucker, Zurich (CH)

Correspondence Address: RISSMAN HENDRICKS & OLIVERIO, LLP, 100 Cambridge Street, Suite 2101, BOSTON, MA, 02114, US

(73) Assignee: Strauman Holding AG, Basel (CH)

(21) Appl. No.: 12/558,840

(22) Filed: Sep. 14, 2009

(30) Foreign Application Priority Data
Sep. 16, 2008 (EP) 08 016254.8

(51) Int. Cl. A61C 8/00

(52) U.S. Cl. 433/201.1

(57) ABSTRACT

One-part dental implant (5) with an anchoring part (10) for anchoring in the bone and with a build-on part (15) for receiving an element to be applied. The build-on part has at least one core (25) and a covering layer (30) which are visually and/or acoustically different from one another.

### FIELD OF THE INVENTION

The present invention relates to a one-part dental implant with an anchoring part for anchoring in the bone and with a build-on part for receiving an element to be applied, such as an abutment or a crown, bridge or prosthetic structure.

### BACKGROUND

Although two-part dental implants are very popular today, they nevertheless have the disadvantage of having inter alia, a lower mechanical stability than one-part dental implants because of the large number of components involved. Moreover, one-part dental implants have the advantage that they do not have a gap between the implant and the element to be applied, and therefore there is no risk of an accumulation of bacteria in the gap which may, for example, cause periodontitis or gingivitis.

Even if a one-part implant is implanted as well as possible, it is unavoidable that major or minor corrections to the implant by the grinding of the coronal part, that is to say the build-on part, have to be carried out, in order to ensure that the prosthetic elements placed on it fit well. However, grinding the build-on part of the implant may result in this build-on part becoming too thin in places, but this is very difficult to detect visually by the dentist. Overall stability is therefore no longer ensured, and this may lead under load to a fracture.

Moreover, implants with an angle between the anchoring part and build-on part have the disadvantage that, because of the angle, the dentist, when screwing in the implant, reaches the correct final position of the implant only every 360°, and because of this he may have to overscrew an implant, for example, through 270°. This could unnecessarily injure the bone tissue and may lead to necroses which adversely influence the establishment of the implant. Furthermore, the implant could rub against the adjacent teeth, the result of which would be that it could not be inserted at all.

### SUMMARY OF THE INVENTION

An object of the present invention is to provide a warning system which advises the dentist that a further grinding of the build-on part could lead to a fracture under load.

According to one embodiment of the present invention, a one-part dental implant is provided with an anchoring part for anchoring in the bone and with a build-on part for receiving an element to be applied. Such an element to be applied is, for example, an abutment or a crown, bridge or prosthetic structure. The build-on part has at least one core and a covering layer, the at least one core and the covering layer are visually and/or acoustically different from one another. The core in this embodiment is part of the build-on part of the implant which is required minimally in order to ensure a sufficient stability of the implant. The minimum dimension of the core depends on the indication, the material and the processing. In contrast in terms of the stability of the implant, the covering layer constitutes an optional layer which, where appropriate, may be ground off completely. The thickness of the covering layer is ideally selected such that, in a standard implantation, as little as possible has to be ground off, so as not to prolong the patient visits unnecessarily. Since the at least one core and the covering layer can be distinguished visually and/or acoustically from one another, the dentist implants an implant having an integrated warning system which, when he is grinding the build-on part, advises him that further grinding would no longer ensure stability.

In one embodiment, there are various possibilities for ensuring that the covering layer can be distinguished visually from the at least one core. The expression “visual” is understood to mean that the difference between the covering layer of the at least one core can be detected by the naked eye. This may be, for example, a different color or deviating color shade.

For example, the at least one core may contain coloring pigments which are not present or are present in a different quantity in the covering layer. Such coloring pigments are preferably selected from the group consisting of iron oxide (Fe₂O₃), iron nitrate (Fe(NO₃)₃), bismuth oxide (Bi₂O₃), cerium oxide (CeO₂), yttrium oxide (Y₂O₃), erbium oxide (Er₂O₃), praseodymium oxide (Pr₆O₁₁), praseodymium nitrate (Pr(NO₃)₃), zinc oxide (ZnO), vanadium oxysulfate (VOSO₄) and mixtures thereof. Moreover, metallic copper nanoparticles, possibly as a mixture with one or more of the above-mentioned pigments, may also be used for the at least one core. In a particularly preferred embodiment, the at least one core contains 0.01 to 0.2 mol % and the covering layer 0.01 to 0.2 mol % of the above coloring pigments. The concentration of the coloring pigments depends not only on the coloring pigment as such, but also on the sintering temperature, since, as shown in FIG. 11, the yellow/blue or the green/red fraction varies according to the sintering temperature (the b* value corresponds to the yellow/blue fraction, a low value corresponding to a high blue fraction and a high value corresponding to a high yellow fraction; the a* value corresponds to the green/red fraction, a low or negative value corresponding to a high green fraction and a high value corresponding to a high red fraction).

Alternatively, it is possible that the at least one core can be distinguished acoustically from the covering layer. The expression “acoustically” is understood to mean that the noise of the drill when the build-on part is being ground is different, depending on whether the at least one core or the covering layer is being ground, the difference being so marked that it can be perceived immediately by the dentist. The acoustically audible difference is generated in that the at least one core has a hardness which is different from that of the covering layer. As soon as the drill meets the harder material, the audible noise is higher than before.

The material used for the covering layer is preferably aluminum oxide (Al₂O₃). Aluminum oxide is a transparent ceramic and is therefore suitable for the covering layer for esthetic reasons. The material used for the at least one core is preferably partly stabilized polycrystalline tetragonal zirconium oxide (tetragonal zirconia polycrystal TZP), in particular yttrium-stabilized TZP (Y-TZP). This material is distinguished by an optimal behavior with regard to hardness and to fracture stability, this, of course, being particularly important for the core.

In a particularly preferred embodiment, the at least one core and the covering layer differ both visually and acoustically from one another, that is to say the dentist has a double warning system. This may be achieved, for example, by the addition of coloring pigments and the strengthening of the core material.

If the implant is to have a straight build-on part, a dental implant according to the invention with exactly one core and a covering layer is preferably used, whereas, in the case of an angled build-on part, a dental implant according to the invention with a plurality of, preferably three, cores and a covering layer is used.

In a further preferred embodiment, the dental implant according to the invention contains three or more cores and a covering layer which are visually distinguishable from one another. That is to say, the at least three cores all have different colors or color shades and, in addition, differ from the covering layer. It is also possible, however, that the at least three cores all have the same color which is different from that of the covering layer. The implant according to this preferred embodiment, then, makes it possible to have maximum screw-in accuracy, since the corresponding build-on part, after being screwed in by the dentist, is ground in situ in the mouth. The three predetermined cores give the dentist clear stipulations as to how far he should grind. Owing to the maximum screw-in accuracy, the bone tissue is protected and a very good healing rate is achieved. These three or more cores are preferably arranged so as to be directed away from the mid-axis at an angle of inclination of 5 to 25°. In a preferred embodiment, the angle of inclination amounts to 15°. Alternatively, here too, it is possible that the three cores and the covering layer differ from one another acoustically, since they have different hardnesses.

The dental implants according to the invention are preferably produced in one piece from a biocompatible ceramic. The one-piece implant ensures high stability, since it has no material differences or microgaps. The biocompatible ceramic is preferably a stabilized zirconium oxide ceramic, particularly preferably 92.1 to 93.5% by weight of ZrO₂ and 4.5 to 5.5% by weight of Y₂O₃ and 1.8 to 2.2% by weight of HfO₂. A zirconium oxide ceramic stabilized in this way has extremely high mechanical stability and strength particularly when produced by means of hot-isostatic pressing or by means of sintering with subsequent hot-isostatic repressing. The covering layer may in this embodiment be sprayed onto the at least one core which differs visually and/or acoustically from the covering layer, and the green body thus obtained can be sintered. The desired one-piece form is thereby achieved.

In a further embodiment, an intermediate layer which has the function of a transition layer is applied between the at least one core and the covering layer. That is to say, said intermediate layer either has a different color from that of the covering layer and of the at least one core or has a hardness which lies between the hardness of the covering layer and the hardness of the at least one core.

In a further embodiment, the covering layer may not only be applied to the build-on part, but also to the anchoring part. The production of an implant according to the invention thereby becomes simpler and more cost-effective.

The anchoring part may be treated by means of a suitable stripping pretreatment or by means of a suitable coating on its outer surface, in order thereby to achieve a good bond osteogenesis after implantation. The anchoring part may, for example, be silanized or hydroxylated on its surface. Particularly preferably, it is roughened by means of a stripping method and etched with hydrofluoric acid. The implant consequently has a surface structure described in EP 07 007 950.4 to which reference is made.

According to another embodiment, a method is provided for making a one-part dental wherein a green body is injection molded having an anchoring part and at least one core, the at least one core containing for example, a coloring pigment, and a covering layer being sprayed onto the at least one core and subsequently being sintered.

### BRIEF DESCRIPTION OF THE DRAWINGS

Further features and advantages may be gathered from the following description of preferred exemplary embodiments, with reference to the drawings in which:

FIG. 1 shows a one-part straight dental implant according to the prior art;

FIG. 2 shows a one-part angled dental implant according to the prior art;

FIG. 3 shows a one-part dental implant according to a first embodiment of the invention;

FIG. 4 shows a section through the implant according to FIG. 3;

FIG. 5 shows a dental implant according to FIG. 3 implanted in the jaw;

FIG. 6 shows a dental implant according to FIG. 5 implanted in ground form in the jaw;

FIG. 7 shows a dental implant according to FIG. 6 with an attached crown;

FIG. 8 shows a dental implant according to a second embodiment with three angled cores;

FIG. 9 shows a section through the implant according to FIG. 8;

FIG. 10 shows the dental implant according to FIG. 8 implanted in the jaw; and

FIG. 11 shows the dependence of the coloring pigments on the sintering temperature.

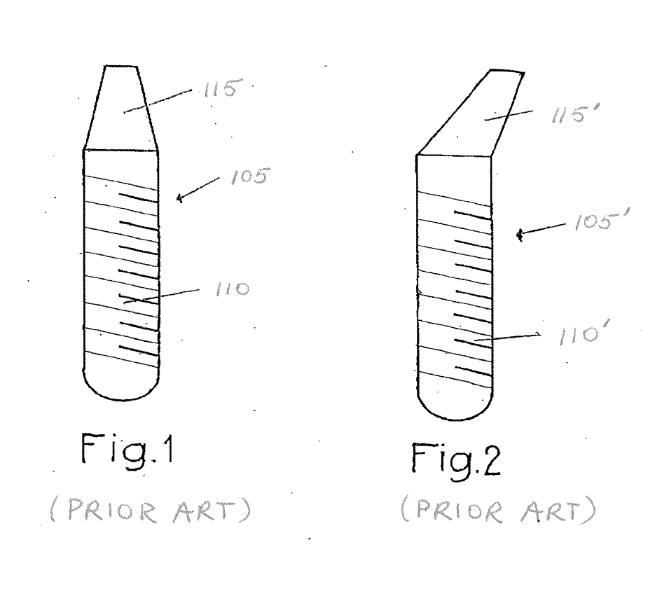

FIG. 1 shows a one-part dental implant 105, such as is known from the prior art. The dental implant 105 has an anchoring part 110 and a build-on part 115 for receiving an element to be applied, such as, for example, a crown. The anchoring part 110 is in the form of a screw thread. Consequently, the surface and therefore the contact area of the anchoring part 110 are increased, thus ensuring good osseointegration. Alternatively, however, the implant could also be intended to be punched in, and, correspondingly, the anchoring part could have no screw thread. The build-on part 115 is straight, that is to say parallel to the mid-axis of the anchoring part.

FIG. 2 shows another one-part dental implant 105′ with an anchoring part 110′ and with a build-on part 115′ for receiving an element to be applied, according to the prior art. In contrast to the dental implant shown in FIG. 1, the build-on part 115′ is sloped, that is to say it has an angle of inclination of up to 25° with respect to the mid-axis of the anchoring part 110′. An angled implant is suitable, inter alia, for being inserted into a maxillary ridge angled with respect to the incisors.

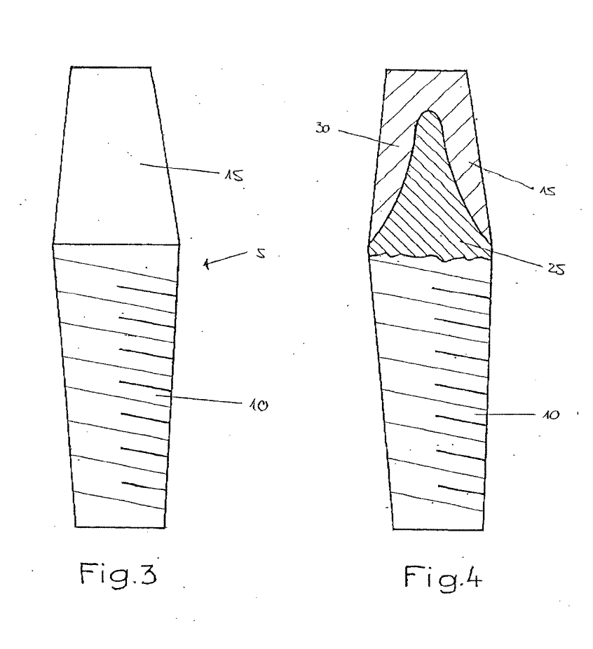

FIG. 3 shows a first embodiment of the implant 5 according to the invention. It has an anchoring part 10 for anchoring in the bone and a build-on part 15 for receiving an element to be applied. The anchoring part 10 has a screw thread portion and preferably a rounded lower end. The anchoring part 10 merges at its upper end, via a portion outwardly widened slightly conically on the outside, into a build-on part 15 which is preferably formed in one piece (integrally) with said anchoring part and which runs in the prolongation of the longitudinal axis of the screw thread portion. The build-on part 15 possesses a frustoconical shape which, after implantation, is ground by the dentist in order to obtain the final shape of the build-on part 15. The build-on part 15 has at least one core 25 and a covering layer 30, the core 25 and the covering layer 30 differing visually from one another (see FIG. 4), that is to say by means of color differences which are perceived visually by the dentist. The dentist thereby has the possibility of grinding the implant individually, without having to worry whether the stability of the implant is no longer ensured, since he is advised by the color change when he should no longer continue to grind. Alternatively, it is also possible that the at least one core 25 and the covering layer 30 differ from one another acoustically during grinding, since they have different hardnesses. The combination of visual and acoustic distinguishability is particularly preferred. The prosthetic element is cemented on after grinding. Alternatively, the at least one core may additionally have an orifice, with or without a screw thread, which makes it easier to fasten a prosthetic element.

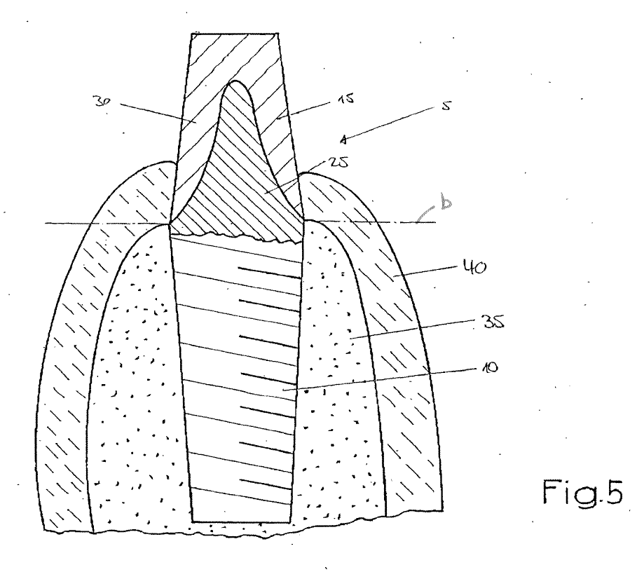

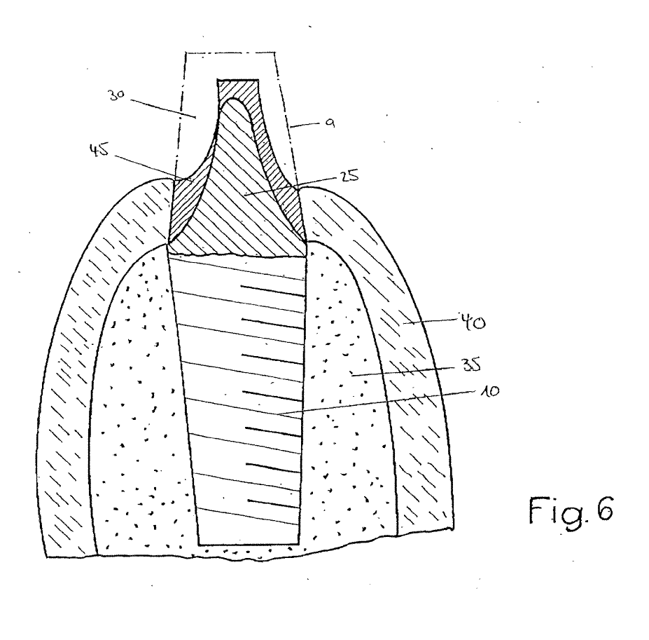

FIG. 5 shows a section through the first embodiment of the implant 5 according to the invention which has been implanted in the jaw. The anchoring part 10 is implanted in the bone tissue 35 (up to broken line b as shown); soft tissue 40 surrounds the bone tissue 35. The build-on part 15 has in this case not yet been ground, that is to say only the covering layer 30 can be seen by the dentist.

FIG. 6 shows the implant of FIG. 5, after grinding, the original shape being indicated by the broken line a. The ground build-on part 45 remaining conforms to the patient's individual needs and ensures the optimal stability of the implant. The core 25, which differs visually and/or acoustically from the covering layer 30, has not been ground in this case.

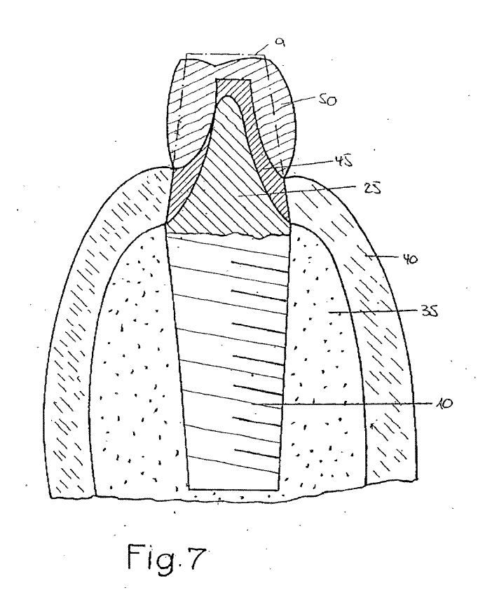

FIG. 7 shows the implant of FIG. 6, the ground build-on part 45 of which has been supplied with a crown 50. The original shape of the implant is again indicated by the broken line a for clearer understanding.

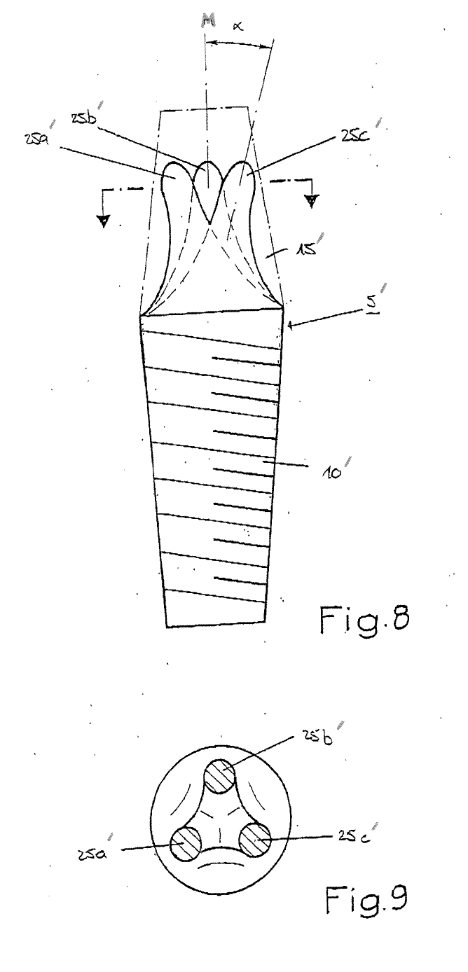

FIG. 8 shows a second embodiment of the implant 5′ according to the invention. The implant 5′ once again has an anchoring part 10′ for anchoring in the bone and a build-on part 15′ for receiving an element to be applied. The build-on part 15′ contains three cores 25a′, 25b′, 25c′ which are arranged symmetrically to a central longitudinal axis of rotation M and at an angle of inclination α of 5 to 25° with respect to the mid-axis M. An angle of inclination α of 15° is particularly preferred in this case. FIG. 9 shows a section through the implant of FIG. 8, in order to show the three cores 25a′, 25b′, 25c′ more clearly. The three cores 25a′, 25b′, 25c′ enable a dentist to grind an angled implant in the case of a difficult jaw position, such as, for example, in the case of a jawbone angled with respect to the incision surface of the teeth. This can be accomplished without the 360° angle, otherwise necessary in the case of prefabricated angled implants, having to be maintained in order to bring the implant into the correct position. As a result, the bone tissue is protected, thus allowing good bone integration. The prosthetic element is cemented on after grinding. Alternatively, or in addition, an orifice, with or without a screw thread, which makes it easier to fasten a prosthetic element, may be arranged centrally between the three cores 25a′, 25b′ and 25c′.

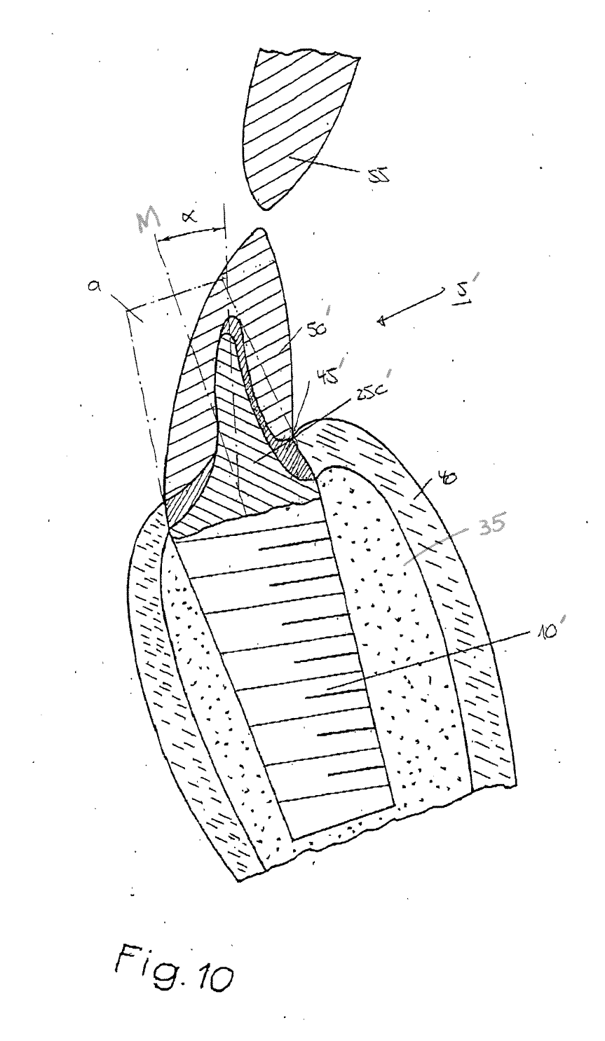

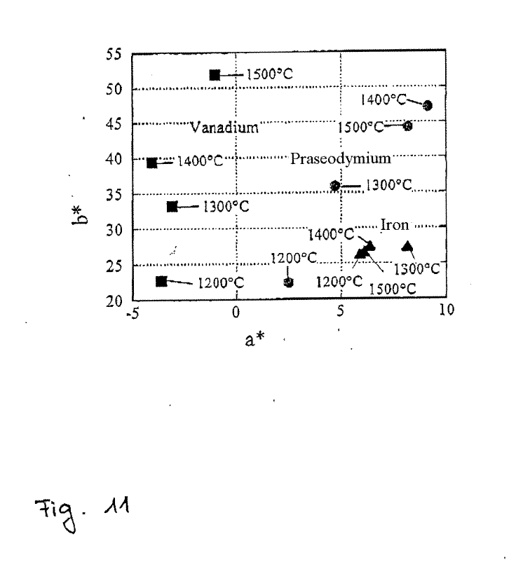

Finally, FIG. 10 shows the implant 5′ of FIG. 8, implanted and ground, which has been provided with a crown 50. By means of the implant 5′ according to the invention, it is possible to grind off the build-on part 15′ such that, despite an angled jawbone, the crown is aligned exactly with the opposite tooth 55, with stability being maintained, this being necessary for an optimal bite.

FIG. 11 shows the dependence of various coloring pigments on the sintering temperature, as may be used in various embodiments of the invention previously disclosed.

1. A one-part dental implant with an anchoring part for anchoring in the bone and with a build-on part for receiving an element to be applied, the build-on part having at least one core and a covering layer, wherein the at least one core and the covering layer are visually and/or acoustically different from one another.

2. The one-part dental implant as claimed in claim 1, which is one-piece.

3. The one-part dental implant as claimed in claim 1, wherein, between the at least one core and the covering layer, an intermediate layer is arranged which is visually or acoustically different from the at least one core and the covering layer.

4. The one-part dental implant as claimed in claim 1, wherein the build-on part has exactly one core and one covering layer.

5. The one-part dental implant as claimed in claim 1, wherein the build-on part has a plurality of cores and a covering layer.

6. The one-part dental implant as claimed in claim 5, wherein the build-on part has three cores and a covering layer.

7. The one-part dental implant as claimed in claim 6, wherein the three cores are arranged symmetrically to a mid-axis of rotation with respect to one another.

8. The one-part dental implant as claimed in claim 7, wherein the three cores are arranged so as to be directed away from the mid-axis at an angle of inclination of 5 to 25°.

9. The one-part dental implant as claimed in claim 8, wherein the angle of inclination is 15°.

10. The one-part dental implant as claimed in claim 5, wherein the cores differ visually and/or acoustically from one another.

11. The one-part dental implant as claimed in claim 1, wherein the core contains a coloring substance selected from the group consisting of iron oxide, iron nitrate, bismuth oxide, cerium oxide, yttrium oxide, erbium oxide, praseodymium oxide, praseodymium nitrate, zinc oxide, vanadium oxysulfate, metallic copper nanoparticles and mixtures thereof.

12. The one-part dental implant as claimed in claim 1, wherein the covering layer contains a coloring substance selected from the group consisting of iron oxide, iron nitrate, bismuth oxide, cerium oxide, yttrium oxide, erbium oxide, praseodymium oxide, praseodymium nitrate, zinc oxide, vanadium oxysulfate and mixtures thereof.

13. The one-part dental implant as claimed in claim 1, wherein the covering layer is aluminum oxide.

14. The one-part dental implant as claimed in claim 1, wherein the at least one core is yttrium-stabilized polycrystalline tetragonal zirconium.

15. A method for producing a one-part dental implant as claimed in claim 1, wherein a green body is injection molded having the anchoring part and the at least one core, the at least one core containing a coloring pigment, and the covering layer being sprayed onto the at least one core and subsequently being sintered.
